(19) United States
(12) Patent Application Publication
(10) Pub. No.: US 2014/0279864 A1
(43) Pub. Date: Sep. 18, 2014

(54) GENERATING DATA RECORDS BASED ON PARSING

(71) Applicant: Google Inc., Mountain View, CA (US)

(72) Inventors: Mikhail Lopyrev, San Francisco, CA (US); Gaurav Jain, San Francisco, CA (US); Bote Deepak Narayan, Sunnyvale, CA (US); Vitaly Repeshko, San Jose, CA (US); Chengling Chan, Burligame, CA (US); Jinan Lou, Cupertino, CA (US)

(73) Assignee: Google Inc., Mountain View, CA (US)

(21) Appl. No.: 14/143,835

(22) Filed: Dec. 30, 2013

Related U.S. Application Data
(60) Provisional application No. 61/783,284, filed on Mar. 14, 2013.

(51) Int. Cl. G06F 17/30

(52) U.S. Cl. CPC G06F 17/30943
USPC 707/609; 707/755; 707/690

(57) ABSTRACT

Methods, systems, and apparatus, including computer programs encoded on a computer storage medium, for receiving a first document, the first document being associated with a user, executing a plurality of parsers, each parser of the plurality of parsers processing the first document to provide one or more first data values, merging the one or more first data values provided from the plurality of parsers to populate a data record having one or more data fields, the data record being specific to the user, and storing the data record in computer-readable memory.

### CROSS-REFERENCE TO RELATED APPLICATIONS

This application claims priority to U.S. Provisional Application Ser. No. 61/783,284, filed on Mar. 14, 2013, the entire contents of which are hereby incorporated by reference.

### BACKGROUND

This specification relates generally to generating data records based on parsing electronic documents.

Conventional electronic data organizers, such as calendars, day planners, to-do lists, allow users to store and retrieve information about events with respect to particular dates and times. Typically, a user creates a data entry that includes at least a date of the event and optionally includes additional information, e.g., a time span or a description of the event.

Sometimes, a user creates such data entries in response to information received as an electronic mail message from a website with which the user has recently interacted. For example, a user can purchase an airline flight itinerary for a flight departing from one location on a particular date and arriving at another location. In some examples, following the purchase of a particular flight itinerary, the online travel booking site sends an electronic confirmation message to the user that includes the purchased itinerary. In some examples, the user can create a calendar entry as a reminder of the flight, and enter information such as time, date, airport, airline, and confirmation number for the flight.

### SUMMARY

Implementations of the present disclosure are directed to generating a data record from an electronic document based on parsed data provided from a plurality of parsers. Implementations of the present disclosure are further directed to merging data records generated from electronic documents.

In general, innovative aspect of the subject matter described in this specification can be embodied in methods that include actions of receiving, by the one or more processors, a first document, the first document being associated with a user, executing, by the one or more processors, a plurality of parsers, each parser of the plurality of parsers processing the first document to provide one or more first data values, merging, by the one or more processors, the one or more first data values provided from the plurality of parsers to populate a data record having one or more data fields, the data record being specific to the user, and storing the data record in computer-readable memory.

Other implementations of this aspect include corresponding systems, apparatus, and computer programs, configured to perform the actions of the methods, encoded on computer storage devices.

These and other implementations can each optionally include one or more of the following features. Executing the plurality of parsers can include identifying that two or more of the plurality of parsers have provided conflicting first data values corresponding to a common data field of the data record, ranking the two or more parsers providing the conflicting first data values, and selecting the first data values provided by the highest ranked parser as the first data values provided from the plurality of parsers. Executing the plurality of parsers can include identifying one or more unpopulated data fields among the one or more data fields in the data record, defining a search query based on the one or more unpopulated data fields, executing a search based on the search query, the search providing at least one search result that is responsive to the search query and descriptive of data values for one or more of the one or more unpopulated data fields, and providing the search result as the data values to populate the one or more unpopulated data fields. The actions can also include receiving a second document, the second document being associated with the user, executing the plurality of parsers, each parser of the plurality of parsers processing the second document to provide one or more second data values, merging the second data values provided from the plurality of parsers to update the data record, detecting, based on one or more of the first data values and one or more of the second data values, that the first document and the second document correspond to the data record, and storing the data record in computer-readable memory. One or more of the plurality of parsers can be a generic parser. One or more of the plurality of parsers can be a pre-defined parser. One or more of the plurality of parsers can be a template-based parser. The first document can be descriptive of an event associated with the user.

Particular implementations of the subject matter described in this specification can be implemented so as to realize one or more of the following advantages. First, a system can more accurately extract information from multiple document formats. Second, the system can combine information from multiple documents to provide a user with more accurate or updated information than may be provided by a single document. Third, the system can provide the user with more complete information than what is included in one or more provided documents.

The details of one or more implementations are set forth in the accompanying drawings and the description below. Other features and advantages will be apparent from the description and drawings, and from the claims.

### DESCRIPTION OF DRAWINGS

FIG. 1 depicts an example system that can be used to execute implementations of the present disclosure.

FIGS. 2A-2B depict example confirmation messages that can be parsed in accordance with implementations of the present disclosure.

FIGS. 3A-3B depict example use cases for data records provided in accordance with implementations of the present disclosure.

FIGS. 4-7 depict example processes that can be executed in accordance with implementations of the present disclosure.

### DETAILED DESCRIPTION

FIG. 1 depicts an example system 100 that can be used to execute implementations of the present disclosure. In the illustrated example, an electronic document 105 is provided to the system 100. In some examples, the electronic document 105 can be an electronic mail message, instant message (IM), short message system (SMS) message, a social networking post, a word processing document, an image, e.g., image recognition, optical character recognition, barcodes, an electronic calendar item, an electronic meeting invitation, an audio transcript, or other appropriate source of information. In some examples, the electronic document 105 includes data that can be used to populate a data record 130. In some examples, an electronic document can be associated with a category. Example categories can include travel, e.g., travel reservations, lodging, e.g., hotel reservations, commerce, e.g., product purchases, events, e.g., theater performances, movies, concerts, sporting events, and restaurants, e.g., restaurant reservation. In some examples, the electronic document 105 can convey a booking confirmation, travel itinerary, hotel reservation confirmation, shipment notification, order tracking update, purchase receipt, restaurant reservation confirmation, or other appropriate forms of data. In some examples, and as discussed in further detail below, a category of an electronic document can be determined based on an identifier and/or data provided in the electronic document.

The electronic document 105 is processed by a collection of parsers 110a-110n. In some implementations, the parsers 110a-110n process the electronic document 105 to provide one or more data values that can be used to populate a data record. In some implementations, the parsers 110a-110n can include pre-defined parsers, template-based parsers, and general parsers.

In some implementations, one or more of the parsers 110a-110n may be general parsers tuned to parse the content and grammar generally used in a selected language or dialect, e.g., English, Spanish, German, Cantonese, Mandarin. In some examples, a general parser can be agnostic to the electronic document 105, e.g., category, and/or the data value that provided the electronic document 105, e.g., vendor. In some examples, the general parser includes one or more regular expressions that can be used to identify potentially relevant information within the document, e.g., dates, names, confirmation numbers.

In some implementations, one or more of the parsers 110a-110n may be template-based parsers tuned to parse the particular structure, content, and/or grammar of selected types of electronic documents. In some examples, a template-based parser can be provided based information known about a source of the document. For example, a vendor, e.g., an airline, can send multiple documents to various users, e.g., confirmation messages to passengers who booked flights. Documents associated with the vendor can be reviewed to determine the location of relevant data values provided in the documents, and a template-based parser can be provided that maps data values in fields of the document to corresponding fields in a data record. In some examples, a single vendor can send multiple document types, consequently, template-based parsers can be specific to types of documents received. For example, an airline can send confirmation messages to passengers who have booked flights, can send update messages to passengers when flight details have changed, and/or can send check-in messages to passengers ahead of the time of travel. In some examples, a confirmation message, an update message, and/or a check-in message can each include relevant information, e.g., flight confirmation number, but the relevant information can be provided in different locations within the respective messages.

In some implementations, one or more of the parsers 110a-110n may be pre-defined parsers. In some examples, a vendor can provide information regarding the manner in which documents sent by the vendor are marked-up, e.g., in extensible mark-up language (XML) or by using HTML metatags, as well as information describing the vocabulary used in the document, e.g., “CONF#,” “Conf. No.,” “Confirmation No.,” “Confirmation Number.” A parser can be defined based on the information, such that the parser, e.g., a pre-defined parser, is specific to the format and vocabulary of the document. In this manner, for example, a pre-defined parser can map data values in fields of the document to corresponding fields in the data record, as discussed in further detail herein.

In some implementations, a subset of the parsers 110a-110n may be identified prior to parsing the document to identify one or more general parsers, template-based parsers, and/or pre-defined parsers that may be used to process the particular electronic document 105. For example, electronic mail messages from “confirmations@flightvendorA.com” may be processed using a particular parser, while electronic messages from “do-not-reply@flightvendorB.net” may be processed using a different the parser. In another example an electronic message from “orders@shoppingvendor.com” may include the subject line “Your receipt.” Such an electronic message may include information such as order date, purchased item quantities and prices, shipping destination address, and/or estimated shipping dates. In some examples, such an electronic message can be processed using a different identified subset of the parsers than an electronic message from “orders@shoppingvendor.com” including the subject line “Your order has shipped,” which may include information such as an order number and a shipment tracking code. Accordingly, one or more parsers can be selected based on a source of the electronic document and/or data provided with the electronic document, e.g., subject line.

The parsers 110a-110n process the electronic document 105 to identify and determine data entities, e.g., values, dates, addresses, names, order numbers, quantities, tracking codes. The entities are provided to a merging module 115 and a populating module 120 for possible inclusion in the data record 130. In some implementations, the data record 130 can include a collection of data fields. In some implementations, one or more of the parsers 110a-110n may provide data entities that can be used to populate, by the populating module 120, a particular field of the data record 130.

Although multiple parsers 110a-110n may provide data, in some implementations only one selected parser can provide a data value that could be used to populate a particular data field. Consequently, the data value from the selected parser can be used to populate the data field. In some examples, two or more of the parsers 110a-110n can provide respective data values that could be used to populate a particular field, and the data value from one of the parsers 110a-110n can be selected to populate the data field. For example, the parser 110a can provide a data value representing a confirmation number and the parser 110b can also provide a data value representing a confirmation number. In some implementations, data values from multiple parsers can be reconciled by the merging module 115 to populate a particular data field of the data record 130 with a single data value. In some implementations, the parsers may be selected based on a priority value and/or a confidence value associated with the parsers.

In some examples, it can be pre-provided that data values from a particular parser are to be used to populate a particular field. For example, and continuing with the example above, it can be pre-provided that data values representing a confirmation number from the parser 110a are to be selected by the merging module 115 to populate a respective field of the data record 130 over any other parser, e.g., over the parser 110b. In some examples, a confidence level can be associated with data values from respective parsers, and data values associated with the highest confidence value can be used to populate the data record 130.

In some examples, one or more of the parsers 110a-110n can be provided as category-specific parsers. As introduced above, example categories can include flight reservations, hotel reservations, purchases, restaurant reservations, and events. Example events can include theater performances, dance performances, concerts, sporting events and the like. For example, the parser 110a can be specific to the flight reservation category and can be provided to retrieve category-specific data values from the electronic document 105, e.g., confirmation number, flight number, departure airport, arrival airport, departure date/time, arrival date/time. As another example, the parser 110b can be specific to the hotel reservation category and can be provided to retrieve category-specific data values from the electronic document 105, e.g., reservation number, check-in date, check-out date, room rate, room type. As another example, the parser 110n can be specific to the purchases category and can be provided to retrieve category-specific data values from the electronic document 105, e.g., product name, product identifier, quantity, cost, estimated shipping date, actual shipping date, tracking number.

In some examples, the data record 130 can be specific to a category, and fields in the plurality of fields can be relevant to the category. For example, the data record 130 can be specific to the flight reservation category and can include category-specific data fields, e.g., confirmation number, flight number, departure airport, arrival airport, departure date/time, arrival date/time. As another example, the data record 103 can be specific to the hotel reservation category and can include category-specific data fields, e.g., reservation number, check-in date, check-out date, room rate, room type. As another example, the data record 130 can be specific to the purchases category and can include category-specific data fields, e.g., product name, product identifier, quantity, cost, estimated shipping date, actual shipping date, tracking number.

The data record 130, once populated is stored in a data repository 125. In some implementations, the data repository 125 can be one or more tables in one or more databases, one or more flat files, or combinations of these and any other appropriate format for the storage and retrieval of information such as the data record 130.

FIGS. 2A-2B depict example confirmation messages that can be parsed in accordance with implementations of the present disclosure. FIG. 2A is an example electronic document 200, provided as an electronic mail message, from which data can be provided to populate a data record. In some implementations, a system for populating data records from electronic documents, such as the system 100 of FIG. 1, may be used to parse one or more data values from the message 200. In the illustrated example, the electronic document 200 is an airline reservation confirmation. The electronic document 200 includes data values such as a sender identity 202, a reservation confirmation code 204, various passenger information fields 206, e.g., name, email address, phone numbers, a departure date 208, and a collection of flight information fields 210, e.g., departure airport and time, arrival airport and time, flight number, seat type. The electronic document 200 also includes data values for arrival time 214 and flight duration 218. The data values parsed from the electronic document 200 can be used to generate and/or populate a data record, e.g., the data record 130.

In some implementations, a pre-defined parser may be configured to identify one or more of the data values 202-210 based on predetermined structural information provided to describe the content of documents similar to the electronic document 200. For example, a pre-defined parser may be configured to identify the departure date 208 based on tags or other structural elements underlying the electronic document 200.

In some implementations, a template based parser may be configured to identify one or more of the data values 202-210 based on predetermined content information provided to describe the content of documents similar to the electronic document 200. For example, a template based parser may be configured to identify the confirmation code 204 based on its proximity to the location of the text “Confirmation code” within the body of the electronic document 200.

In some implementations, a general parser may be configured to identify one or more of the data values 202-210 based on information parsed from the content of the electronic document 200. For example, a general parser may be configured to identify that text such as “confirmation code,” “conf. #,” and “reservation number,” may be proximal to other text that can be parsed as the confirmation code 204.

FIG. 2B is an example electronic document 250 from which data can be provided to populate a data record. In some implementations, a system for populating data records from electronic documents, such as the system 100 of FIG. 1, may be used to parse one or more data values from the electronic document 250. In the illustrated example, the electronic document 250 is an airline reservation confirmation that can be a supplement to or an update of the electronic document 200. The electronic document 250 includes data values such as the sender identity 202 and the reservation confirmation code 204. In some implementations, values such as the sender identity 202 and/or the reservation confirmation code 204 can be used to determine that the electronic document 250 pertains to the same flight that was described in the electronic document 200. As such, it can be determined that the electronic document 250 can be used to supplement or update an existing data record.

While some of the information in the electronic document 250 is the same as in the electronic document 200, other information may be added, removed, or altered compared to corresponding information in the electronic document 200. For example, the electronic document 200 includes the arrival time 214 and the flight duration 220. The electronic document 250 includes an arrival time 254 and a flight duration 258 that differ from the arrival time 214 and the flight duration 220. Since the electronic document 250 may be determined as corresponding to the same flight described by the prior electronic document 200, the data values parsed as the arrival time 254 and the flight duration 258 may be used to update corresponding values in the existing data record, e.g., the data record 130.

In the illustrated example, the electronic document 250 also includes data values for a seat number 256 and a gate identifier 260, which were not provided in the electronic document 200. Since the electronic document 250 may be determined as corresponding to the same flight described by the prior electronic document 200, the data values parsed as the seat number 256 and the gate identifier 260 may be used to update previously unfilled values in the data record, e.g., the data record 130.

FIGS. 3A-3B depict example use cases for data records provided in accordance with implementations of the present disclosure. FIG. 3A is an example of a user interface 301 for an example data record representation 310. A user device 300, e.g., a smart phone, tablet, portable computer, wearable computer, vehicle telematics system, presents information from a data record, such as the data record 130, to a user through the representation 310. In the illustrated example, the representation 310 presents information, based on a data record, about an upcoming flight, e.g., the flight described in the electronic documents 200 and 250. In some examples, in response to detecting that the flight is impending, e.g., the user's flight departs in two hours, the device 300 can present at least some of the data from the corresponding data record in the representation 310.

The representation 310 includes a notification type element 312, an airport identification element 314, and an estimated time to departure element 316. In the illustrated example, the information presented by the elements 312-316 is based on values parsed directly from the electronic documents 200, 250. The representation 310 also includes a map element 318, and a navigation element 320 corresponding to the location of the departure airport. In the examples of the electronic documents 200 and 250, however, no address was provided.

In some implementations, a data record such as the data record 130 may be augmented with information provided by sources other than electronic documents provided to the system 100. For example, the system 100 may process the electronic documents 200, 250 to populate the data record 130 corresponding to the category type described by the electronic documents 200, 250. The system 100 may also identify fields in the data record 130 that are normally associated with the determined event type, but were not populated, e.g., the information was not provided or was not parsed by the parsers 110a-110n.

In such examples, the system 100 may determine a search query based on parsed values, and use the search query a search engine to identify information that can be used as a substitute for the missing information. In the example of the electronic documents 200, 250, an airport name “Minneapolis/St. Paul (MSP)” was provided without an address. The system 100 may identify that the airport address is missing from the resulting data record 130, and engage a search engine to find the address for and “airport Minneapolis St. Paul MSP”. The search engine may respond with “4300 Glumack Dr, St Paul, Minn.”, which the system 100 may use to populate the missing address field in the data record 130, and later present on the map element 318 or as the destination for the navigation element 320.

FIG. 3B is another example of a data record representation 350. In the illustrated example, the user device 300 presents the representation 350 through the user interface 301. In the illustrated example, the representation 350 presents additional information, based on a data record, about an upcoming flight that the user is about to board, e.g., the flight described in the electronic documents 200 and 250. In response to detecting that the flight is likely to be in the process of boarding, e.g., the user's flight departs in 57 minutes, the device 300 can present at least some of the data from the corresponding data record in the representation 350.

The representation 350 includes the notification type element 312 and a collection of information elements 352. In the illustrated example, the information presented by the elements 352 is based on values parsed from the electronic documents 200, 250, such as a terminal identifier, a gate number, a seat number, an electronic boarding pass barcode, and other appropriate information. The representation 350 also includes a link element 354. When selected, the link element 345 can cause the user interface 301 to display the electronic documents 200, 250 from which the information in the representation 350 was parsed.

In the examples of FIGS. 3A and 3B, the representations 300, 350 were visual or graphical representations of information from the data record 130. In some implementations, the information may presented in other ways. For example, the information may be audible, e.g., spoken, provided as data to another device, e.g., to set a destination for a built-in vehicle navigation system, or combinations of these and other appropriate ways of providing data from the data record 130 to the user.

Accordingly, implementations of the present disclosure are directed to recording data values provided in one or more electronic documents, using one or more document parsers, to a data record. In some examples, data values related to travel itineraries, hotel reservations, order tracking, purchase receipts, and/or event bookings, can be retrieved from electronic documents. More particularly, implementations of the present disclosure are directed to using multiple parsers to provide data values from one or more document, and populate and/or update a data record. In some examples, two or more parsers, e.g., a general language parser and a document-specific parser, can be used to provide information from a single electronic document, and the information is merged into a data record. In some examples, one or more parsers can be used to provide information from an electronic document, information missing from an existing data record can be determined, and the information provided from the electronic document can be merged into the existing data record as the missing information. In some examples, one or more parsers can be used to provide information from an electronic document, it can be determined that the electronic document correspond to an existing data record, and the information can be merged into the existing data record.

FIGS. 4-7 depict example processes that can be executed in accordance with implementations of the present disclosure.

FIG. 4 is a flow chart showing an example processes 400 for building a data record from a received document. In some implementations, the process 400 can be performed by the system 100 of FIG. 1.

At 405, an electronic document is received. The electronic document is associated with a user. For example, the system 100 can receive the electronic document 105. At 410, a collection of parsers is received. For example, the system 100 can receive the collection of parsers 110a-110n.

At 415, a collection of parsers is executed to process the electronic document. Each parser processes the electronic document to provide on or more data values. For example, the parsers 110a-100n can process the electronic document 105 to identify and extract one or more values provided by the document.

In some implementations, one or more of the collection of parsers can be generic parsers. In some implementations, one or more of the collection of parsers can be predefined parsers. In some implementations, one or more of the collection of parsers can be template-based parsers.

At 420, the data values from the collection of parsers are merged to populate one or more data fields of a data record that is specific to the user. For example the merging module 115 merges the data values provided by the parsers 110a-110n. At 425, the data set is populated with the data values. For example, the populating module 120 places the data values into fields of the data record 130. At 430, the data record is stored. For example, the data record 130 is stored in the data repository 125.

FIG. 5 is a flow chart showing an example processes 500 for building a data record from a received document. In general, the process 500 is used to select a single value when two or more different data values for the allegedly same data field are provided by two or more parsers. In some implementations, the process 500 can be performed by the system 100 of FIG. 1. In some implementations, the process 500 can be performed in addition to the process 400 of FIG. 4.

At 505, data values provided by multiple parsers is processed to identify that two or more of the collection of parsers have provided conflicting data values corresponding to a common data field of the data record. For example, at 415 the document, e.g., the electronic document 200, is processed using multiple parsers. The parser 110a and 110b may both identify a “confirmation number” value, however the parser 110a may return a confirmation number value of “ABCD123” while the parser 110b may return a confirmation number value of “XYZ987”.

If no conflict is identified, then the data values are merged at 420. If a conflict is detected, then at 510 the two or more parsers providing the conflicting data values are ranked. For example, the parser 110a may be a general purpose parser, while the parser 110b may be a pre-defined parser for confirmation emails provided by “resconfirm@airline.com”, e.g., the sender of the electronic document 200. In such an example, the pre-defined parser may be better configured to process the electronic document 200 than the general purpose parser, and therefore the pre-defined parser may be ranked higher than the general purpose parser.

At 515, the data values provided by the highest ranked conflicting parser are selected. For example, the confirmation number value “XYZ987” provided by the pre-defined parser, e.g., the parser 110b, may be selected over the confirmation number value “ABCD123” provided by the general purpose parser, e.g., the parser 110a. The selected values are then merged at 420.

FIG. 6 is a flow chart showing an example processes 600 for building a data record from a received document. In general, the process 600 can be used to fill empty data fields in a data record by searching supplemental information based information already known from the data record. In some implementations, the process 600 can be performed by the system 100 of FIG. 1. In some implementations, the process 600 can be performed in addition to the process 400 of FIG. 4.

At 605, the data record is processed to identify one or more unpopulated data fields among the one or more data fields of the data record. If no unpopulated fields are identified, then the process 600 continues at 420. If unpopulated fields are identified, then the process 600 continues at 610. For example, the data record 130 may be processed by the system 100 to determine that it is a hotel reservation data record, but no address has been stored in an “address” data field of the data record 130.

At 610, a search query is defined based on the one or more unpopulated data fields. For example, the system 100 may determine that the “address” field empty, so a search query for “address” may be defined. In some implementations, the search query may be defined also using data stored in filled data fields of the data record. For example, the data record 130 may include a “hotel name” data field filled with the value “Brownsdale Acme Hotel”, and the search query may be defined as “address of Brownsdale Acme Hotel”.

At 615, a search is executed based on the search query. The search provides at least one search result that is responsive to the search query and is descriptive of data values of the one or more unpopulated data fields. Continuing the previous address example, the system 100 may request a search for “address of Brownsdale Acme Hotel” from a search engine, and the search engine may respond with “201 North Mill Street, Brownsdale, Minn.”, e.g., the address of the hotel.

At 620, the search result is provided as the data values to populate the one or more unpopulated data fields. For example the search result “201 North Mill Street, Brownsdale, Minn.” may be provided to the merging module 115 as an “address” data field for the data record 130. The data values are merged at 420.

FIG. 7 is a flow chart showing an example processes 700 for building a data record from a received document. In general, the process 700 may be performed to update an existing data record using information parsed from multiple electronic documents, such as an initial document and a subsequently received update document. In some implementations, the process 700 can be performed by the system 100 of FIG. 1. In some implementations, the process 700 can be performed in addition to the process 400 of FIG. 4.

At 705 a second document is received. For example, the process 400 may receive and process the electronic document 200 of FIG. 2A, and at step 705 the system 100 may receive the electronic document 250 of FIG. 2B.

At 710, a collection of parsers is executed to process the second electronic document. Each parser processes the second electronic document to provide on or more data values. For example, the parsers 110a-100n can process the electronic document 250 to identify and extract one or more second values provided by the document 250.

At 715, the second data values from the collection of parsers are merged. For example the merging module 115 can merge the data values provided by the parsers 110a-110n.

At 720 a determination is made, based on one or more of the data values stored in the data record and one or more of the second values, that the first and second documents correspond to the same data record. For example, while the electronic documents 200 and 250 differ in content, both electronic documents 200, 250 describe the same flight.

If at 720, it is determined that the second document does not describe the same event as the first document, then the second document is treated as describing a new event by continuing at 425 of the process 400 where the second values are used to populate a new data record that is stored at 430.

If, however, at 720 it is determined that the second document describes the same event as the first document, then at 725 the existing data record is updated with the second data values, and the updated data record is stored at 430. For example, the data record 130 may include data values parsed from the electronic document 200, and the electronic document may be updated with data values parsed from the electronic document 250.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed using one or more processors, the method comprising:
receiving, by the one or more processors, a first document, the first document being associated with a user;
executing, by the one or more processors, a plurality of parsers, each parser of the plurality of parsers processing the first document to provide one or more first data values;
merging, by the one or more processors, the one or more first data values provided from the plurality of parsers to populate a data record having one or more data fields, the data record being specific to the user; and
storing the data record in computer-readable memory.

2. The method of claim 1, wherein executing the plurality of parsers comprises:
identifying that two or more of the plurality of parsers have provided conflicting first data values corresponding to a common data field of the data record;
ranking the two or more parsers providing the conflicting first data values; and
selecting the first data values provided by the highest ranked parser as the first data values provided from the plurality of parsers.

3. The method of claim 1, wherein executing the plurality of parsers comprises:
identifying one or more unpopulated data fields among the one or more data fields in the data record;
defining a search query based on the one or more unpopulated data fields;
executing a search based on the search query, the search providing at least one search result that is responsive to the search query and descriptive of data values for one or more of the one or more unpopulated data fields; and
providing the search result as the data values to populate the one or more unpopulated data fields.

4. The method of claim 1, further comprising:
receiving a second document, the second document being associated with the user;
executing the plurality of parsers, each parser of the plurality of parsers processing the second document to provide one or more second data values;
merging the second data values provided from the plurality of parsers to update the data record;
detecting, based on one or more of the first data values and one or more of the second data values, that the first document and the second document correspond to the data record; and
storing the data record in computer-readable memory.

5. The method of claim 1, wherein one or more of the plurality of parsers is a generic parser.

6. The method of claim 1, wherein one or more of the plurality of parsers is a pre-defined parser.

7. The method of claim 1, wherein one or more of the plurality of parsers is a template-based parser.

8. A system comprising:
a data store for storing data; and
one or more processors configured to interact with the data store, the one or more processors being further configured to perform operations comprising:
receiving, by the one or more processors, a first document, the first document being associated with a user;
executing, by the one or more processors, a plurality of parsers, each parser of the plurality of parsers processing the first document to provide one or more first data values;
merging, by the one or more processors, the one or more first data values provided from the plurality of parsers to populate a data record having one or more data fields, the data record being specific to the user; and
storing the data record in computer-readable memory.

9. The system of claim 8, wherein executing the plurality of parsers comprises:
identifying that two or more of the plurality of parsers have provided conflicting first data values corresponding to a common data field of the data record;
ranking the two or more parsers providing the conflicting first data values; and
selecting the first data values provided by the highest ranked parser as the first data values provided from the plurality of parsers.

10. The system of claim 8, wherein executing the plurality of parsers comprises:
identifying one or more unpopulated data fields among the one or more data fields in the data record;
defining a search query based on the one or more unpopulated data fields;
executing a search based on the search query, the search providing at least one search result that is responsive to the search query and descriptive of data values for one or more of the one or more unpopulated data fields; and
providing the search result as the data values to populate the one or more unpopulated data fields.

11. The system of claim 8, the operations further comprising:
receiving a second document, the second document being associated with the user;
executing the plurality of parsers, each parser of the plurality of parsers processing the second document to provide one or more second data values;
merging the second data values provided from the plurality of parsers to update the data record;
detecting, based on one or more of the first data values and one or more of the second data values, that the first document and the second document correspond to the data record; and
storing the data record in computer-readable memory.

12. The system of claim 8, wherein one or more of the plurality of parsers is a generic parser.

13. The system of claim 8, wherein one or more of the plurality of parsers is a pre-defined parser.

14. The system of claim 8, wherein one or more of the plurality of parsers is a template-based parser.

15. A computer readable medium storing instructions that, when executed by one or more processors, cause the one or more processors to perform operations comprising:
receiving, by the one or more processors, a first document, the first document being associated with a user;
executing, by the one or more processors, a plurality of parsers, each parser of the plurality of parsers processing the first document to provide one or more first data values;
merging, by the one or more processors, the one or more first data values provided from the plurality of parsers to populate a data record having one or more data fields, the data record being specific to the user; and
storing the data record in computer-readable memory.

16. The computer readable medium of claim 15, wherein executing the plurality of parsers comprises:
identifying that two or more of the plurality of parsers have provided conflicting first data values corresponding to a common data field of the data record;
ranking the two or more parsers providing the conflicting first data values; and
selecting the first data values provided by the highest ranked parser as the first data values provided from the plurality of parsers.

17. The computer readable medium of claim 15, wherein executing the plurality of parsers comprises:
identifying one or more unpopulated data fields among the one or more data fields in the data record;
defining a search query based on the one or more unpopulated data fields;
executing a search based on the search query, the search providing at least one search result that is responsive to the search query and descriptive of data values for one or more of the one or more unpopulated data fields; and
providing the search result as the data values to populate the one or more unpopulated data fields.

18. The computer readable medium of claim 15, the operations further comprising:
receiving a second document, the second document being associated with the user;
executing the plurality of parsers, each parser of the plurality of parsers processing the second document to provide one or more second data values;
merging the second data values provided from the plurality of parsers to update the data record;
detecting, based on one or more of the first data values and one or more of the second data values, that the first document and the second document correspond to the data record; and
storing the data record in computer-readable memory.

19. The computer readable medium of claim 15, wherein one or more of the plurality of parsers is a generic parser.

20. The computer readable medium of claim 15, wherein one or more of the plurality of parsers is a pre-defined parser or a template-based parser.
